(19) United States
(12) Patent Application Publication
(10) Pub. No.: US 2026/0155516 A1
(43) Pub. Date: Jun. 4, 2026

(54) BATTERY MODULE ASSEMBLY FOR MACHINE

(71) Applicant: CATERPILLAR INC., Peoria, IL (US)

(72) Inventors: Joseph S. CHABURA, Aurora, IL (US); Brian C. HOWSON, Bolingbrook, IL (US); Phil L. ERNAT, Peru, IL (US); Wayne E. HARSHBERGER, II, Oswego, IL (US)

(73) Assignee: CATERPILLAR INC., Peoria, IL (US)

(21) Appl. No.: 18/911,493

(22) Filed: Oct. 10, 2024

(51) Int. Cl. H01M 50/249; H01M 10/613; H01M 10/625; H01M 50/267

(52) U.S. Cl. CPC H01M 50/249; H01M 10/613; H01M 10/625; H01M 50/267; H01M 2220/20

(57) ABSTRACT

A battery module assembly may have a stair-step floor plate having a first shelf and a second shelf spaced apart from the first shelf along a first direction. The battery module assembly may have a rear plate extending in the first direction. Further, the battery module assembly may have a pair of side plates extending between a front end and a rear end of the floor plate, and connected to one or more of the floor plate and the rear plate. The battery module assembly may have a first battery array positioned on the first shelf and a second battery array positioned on the second shelf. At least one battery module of the first battery array and the second battery array may be attached to at least one of the pair of side plates.

### TECHNICAL FIELD

The present disclosure relates generally to a battery module assembly and, more particularly, to a battery module assembly for a machine.

### BACKGROUND

Machines such as dozers, loaders, excavators, motor graders, and/or other types of machinery include a prime mover that provides power for propulsion of the machine over a ground surface. The prime mover also provides power to drive various components of the machine including, for example, pumps that may supply hydraulic fluid to one or more actuators. Typically, the prime mover includes a combustion engine. However, to address the environmental effect of exhaust gases and other emissions from combustion engines, the combustion engine may be replaced or supplemented by one or more electrical motors.

Such electric motors are typically powered by one or more battery modules that must be accommodated on the machine. The volume occupied by the batteries may be larger than that otherwise occupied by the combustion engine and fuel tank. Thus, there is a need to configure the battery modules such that they can be accommodated on the machine without requiring any increase in a length, a width, and/or a height of the machine relative to a machine equipped with a combustion engine as the only prime mover.

U.S. Patent Publication No. 2013/0078071 A1, published on Mar. 28, 2013 (“the '071 publication”), and discloses an electric hydraulic shovel. The hydraulic shovel of the '071 publication includes, among other things, an electric motor, an inverter, and a battery device that is formed by connecting a plurality of battery modules. The hydraulic shovel also includes a vehicle main body and a detachable vehicle rear part. The battery storage structure of the '071 publication is mounted on the base frame of the vehicle rear part of the electric shovel using antivibration rubbers. The battery storage structure includes a plurality of battery tables vertically spaced apart from each other, with battery modules being located on each of the battery tables. The '071 publication discloses that when it is necessary to replace the battery device, after it has been used for a long time, the rear vehicle part can be detached and replaced with a different rear vehicle part containing fully charged batteries.

Although the '071 publication discloses a removable and replaceable battery storage structure, the battery storage structure of the '071 publication may not provide an optimal arrangement of the batteries. For example, the battery storage structure of the '071 publication may occupy a volume that may increase a length, width, or height of the hydraulic shovel relative to a hydraulic shovel equipped with a combustion engine as the only prime mover. As another example, the battery storage structure of the '071 publication may occupy a volume that may limit a rearward view available to an operator of the machine. Additionally, although the '071 publication allows for changing depleted batteries onsite, such battery replacement operations may cause the machine to be removed from service while the batteries are being replaced, which in turn may increase costs associated with operating the machine.

The battery module assembly of the present disclosure solves one or more of the problems set forth above and/or other problems of the prior art.

### SUMMARY

In one aspect, the present disclosure is directed to a battery module assembly. The battery module assembly may include a floor plate having a stair-step shape. The floor plate may include a first shelf and a second shelf spaced apart from the first shelf along a first direction generally perpendicular to the first shelf and the second shelf. The battery module assembly may include a rear plate extending in the first direction from a rear end of the floor plate. Further, the battery module assembly may include a pair of side plates extending between a front end of the floor plate and the rear end of the floor plate. The sides plate may be connected to one or more of the floor plate, the inner plate, and the rear plate. The battery module assembly may include a first battery array including a first plurality of battery modules positioned on the first shelf. The battery module assembly may also include a second battery array including a second plurality of battery modules positioned on the second shelf. At least one battery module of the first battery array and second battery array may be attached to at least one of the pair of side plates.

In another aspect, method of arranging battery modules in a machine. The method may include providing a floor plate having a stair-step shape. The floor plate may include a first shelf and a second shelf spaced apart from the first shelf along a first direction generally perpendicular to the first shelf and the second shelf. The method may include providing a rear plate extending in the first direction from a rear end of the floor plate. The method may include providing a pair of side plates extending between a front end of the floor plate and the rear end of the floor plate. The sides plate may be connected to one or more of the floor plate, the inner plate, and the rear plate. The method may include arranging a first battery array including a first plurality of battery modules on the first shelf and arranging a second battery array including a second plurality of battery modules on the second shelf.

In yet another aspect, the present disclosure is directed to a machine. The machine may include a frame extending from a front end to a rear end and including a tub adjacent to the rear end. The machine may also include a rear axle extending transverse to the frame adjacent to the rear end of the frame, and a pair of traction devices attached to opposite ends of the rear axle. Further, the machine may include a battery module assembly receivable in the tub. The battery module assembly may include a floor plate having a stair-step shape, the floor plate including a first shelf and a second shelf spaced apart from the first shelf along a first direction generally perpendicular to the first shelf and the second shelf. Further, the battery module assembly may include a rear plate extending in the first direction from a rear end of the floor plate. The battery module assembly may also include a pair of side plates extending between a front end of the floor plate and the rear end of the floor plate. The side plates may be connected to at least one of the floor plate, the inner plate, and the rear plate. The battery module assembly may include a first battery array positioned on the first shelf, the first battery array including a first plurality of battery modules. Further, the battery module assembly may include a second battery array positioned on the second shelf, the second battery array including a second plurality of battery modules. The first battery array and the second battery array may be arranged along a departure plane of the machine.

### BRIEF DESCRIPTION OF THE DRAWINGS

FIG. 1 is a diagrammatic illustration of an exemplary disclosed machine;

FIG. 2 is a diagrammatic illustration of an exemplary chassis of the machine of FIG. 1;

FIG. 3 is a diagrammatic illustration of an exemplary battery module assembly positioned on the chassis of FIG. 2;

FIG. 4 is a diagrammatic illustration of the battery module assembly of FIG. 3;

FIG. 5 is a magnified, perspective view of an exemplary floor plate of the battery module assembly of FIG. 3;

FIG. 6 is a magnified perspective view of an exemplary battery module included in the battery module assembly of FIG. 3;

FIG. 7 is a diagrammatic illustration of another battery module assembly; and

FIG. 8 is a diagrammatic illustration of another battery module assembly.

### DETAILED DESCRIPTION

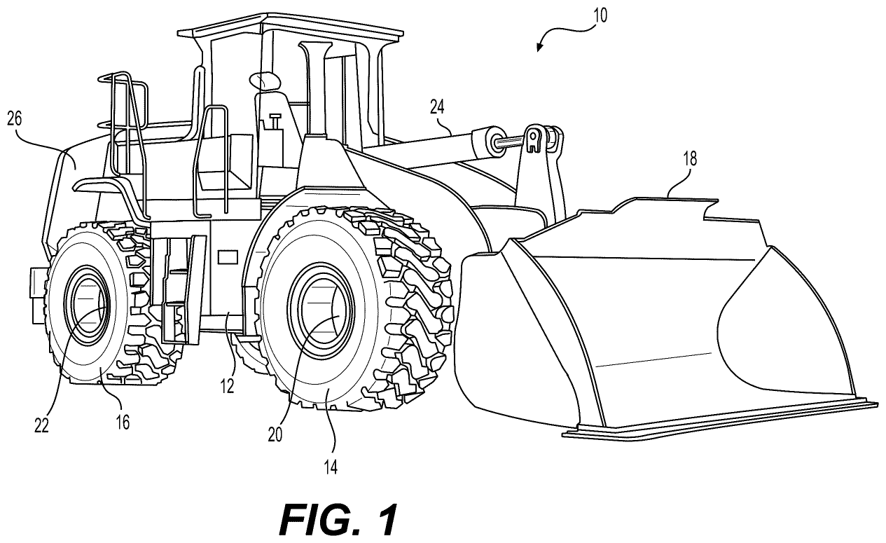

FIG. 1 illustrates an exemplary machine 10. In the depicted embodiment, the machine 10 is a wheel loader. However, machine 10 may embody another type of mobile machine such as an excavator, a shovel, a continuous miner, a loader, a truck, a track-type-tractor, a motor grader, an articulated haul truck, an off-highway mining truck, or another construction or non-construction machine known in the art. Machine 10 may include chassis 12, front and rear traction devices 14 and 16, at least one working implement 18, and a prime mover (not shown). Traction devices 14 may include two or more traction devices attached to opposite sides of front axle 20 and traction devices 16 may include two or more traction devices attached to opposite sides of rear axle 22. Front and rear traction devices 14 and 16, respectively, may support chassis 12 on a ground surface. In one exemplary embodiment as illustrated in FIG. 1, traction devices 14 and 16 may take the form of wheels, although other types of traction devices such as crawler tracks are also contemplated.

The prime mover may include a hybrid-powered engine including a combustion engine and one or more electric motors that may individually or in combination provide power for propulsion and operation of machine 10. Alternatively, the prime mover may include a fully electric prime mover, including one or more electric motors that may provide power for propulsion and operation of machine 10. The prime mover may be configured to propel the one or more traction devices 14 and 16 and deliver power to operate one or more other components or accessory devices (e.g. pumps, fans, motors, generators, belt drives) associated with machine 10. The one or more electric motors may also be configured to drive one or more pumps that may be configured to deliver hydraulic fluid to one or more actuators 24 that may be configured to move working implement 18. One or more batteries, located within body 26 of machine 10, may supply electrical power to the one or more electric motors of the prime mover. In a hybrid-powered engine configuration, the combustion engine may also periodically supply power for charging the batteries.

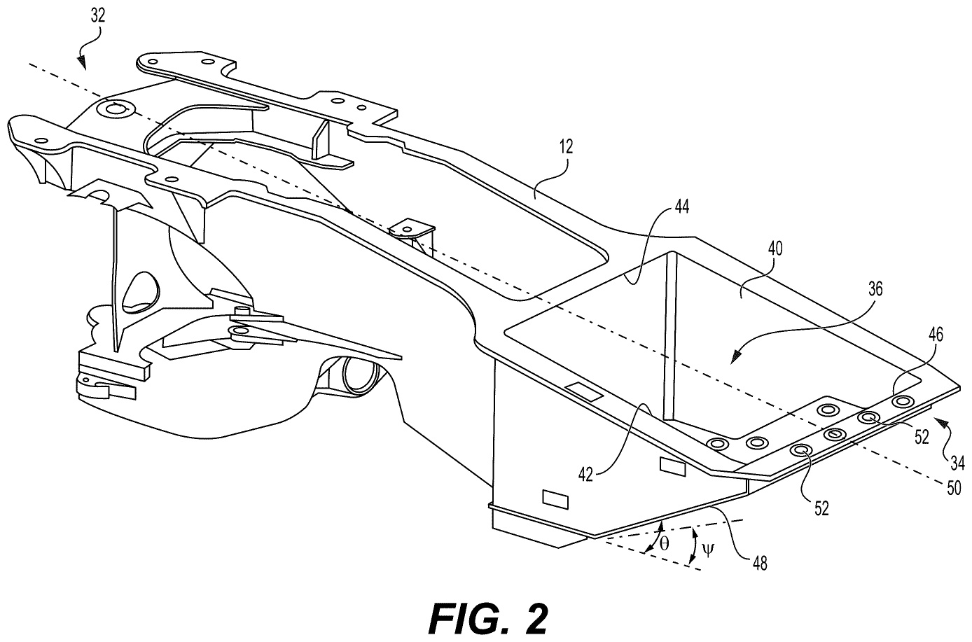

FIG. 2 illustrates an exemplary chassis 12 of machine 10. Chassis 12 may extend from front end 32 to rear end 34. As used in this disclosure the terms front and rear should be understood to express directions relative to each other. For example, machine 10 when moving in a forward direction moves in a direction extending from rear end 34 towards front end 32, and when moving in a rearward direction moves in a direction extending from front end 32 towards rear end 34. Chassis 12 may include tub 36 (e.g., a recess) located adjacent to rear end 34 and configured to hold one or more batteries (not shown in FIG. 2) or battery modules (not shown in FIG. 2).

Tub 36 may be defined by side walls 40, 42, 44, and 46, and bottom wall 48. Side walls 40 and 42 of tub 36 may be disposed generally parallel to and spaced apart from each other. Side walls 40 and 42 may also be disposed generally parallel to longitudinal axis 50 of chassis 12 extending in a direction from front end 32 towards rear end 34. Side walls 44 and 46 may be disposed generally parallel to and spaced apart from each other. Side walls 44 and 46 may be arranged in a direction transverse to longitudinal axis 50, side wall 40, and side wall 42. Side walls 44 and 46 may extend from side wall 40 to side wall 42 and may be connected to side walls 40 and 42. Bottom wall 48 may be connected to side walls 40, 42, 44, and 46 and may define a closed end of tub 36. In one exemplary embodiment as illustrated in FIG. 2, side walls 40, 42, 44, and 46 may define a generally rectangular or square shape. In other exemplary embodiments, 40, 42, 44, and 46 may define, for example, polygonal, circular, elliptical or other shapes. Bottom wall 48 may include a first portion generally parallel to a horizontal plane extending through longitudinal axis 50 and an second portion angled relative to longitudinal axis 50 and angled relative to side walls 40, 42, 44, and 46. As used in this disclosure, the term angled should be interpreted as being different from generally parallel or generally perpendicular to another surface. Furthermore, the terms about and generally should be interpreted as encompassing commonly understood design and manufacturing tolerances. Thus, for example, surfaces or elements that are generally parallel to each other may be arranged at angles of about 0°±5°. Similarly, for example, surfaces or elements that are generally perpendicular to each other may be arranged at angles of and 90°±5°. As illustrated in FIG. 2, bottom wall 48 may be positioned at an angle θ relative to longitudinal axis 50. When machine 10 is supported on a generally flat, horizontal ground surface, bottom wall 48 of chassis 12 may be disposed at angle q relative to the ground surface.

A vertical plane may be defined passing through longitudinal axis 50 generally perpendicular to a horizontal plane or aligned with a direction of gravity. A departure plane for machine 10 may be defined as a plane perpendicular to the vertical plane but angled relative to a horizontal plane. The angle between the departure plane and the horizontal plane generally defines a departure plane angle φ (see FIG. 2). A front portion of chassis 12 (e.g., adjacent to front traction devices 14) may be tilted relative to the ground surface during operations of machine 10 by an angle equal to or less than the departure plane angle f, while maintaining stability of machine 10. Chassis 12 may be tilted during operations of machine 10, for example, when one or both front traction devices 14 are positioned on a mound of earth or other material above a ground surface while rear traction devices 16 remain on the ground surface. The departure plane angle φ may define an angle of inclination of the chassis at which bottom wall 48 may barely touch the ground surface. The angle θ of bottom wall 48 may be greater than or about equal to the departure angle φ such that even when a front portion of chassis 12 (e.g., adjacent to front traction devices 14) is tilted at the departure angle φ, bottom wall 48 does not touch the ground surface.

Chassis 12 may be supported by front traction devices 14 (see FIG. 1) positioned adjacent front end 32, and rear traction devices 16 positioned adjacent rear end 34. In one exemplary embodiment, tub 36 may be at least partially located rearward of rear traction device 16. That is, at least a portion of tub 36 may be located between rear end 34 and rear traction devices 16. Chassis 12 may also include one or more mounting holes 52 that may be configured to receive one or more fasteners (not shown) for attaching a battery module (not shown in FIG. 2) to chassis 12. The number, shape, and size of mounting holes 52 illustrated in FIG. 2 is exemplary, and chassis 12 may include any number of mounting holes having the same or different shapes and/or sizes.

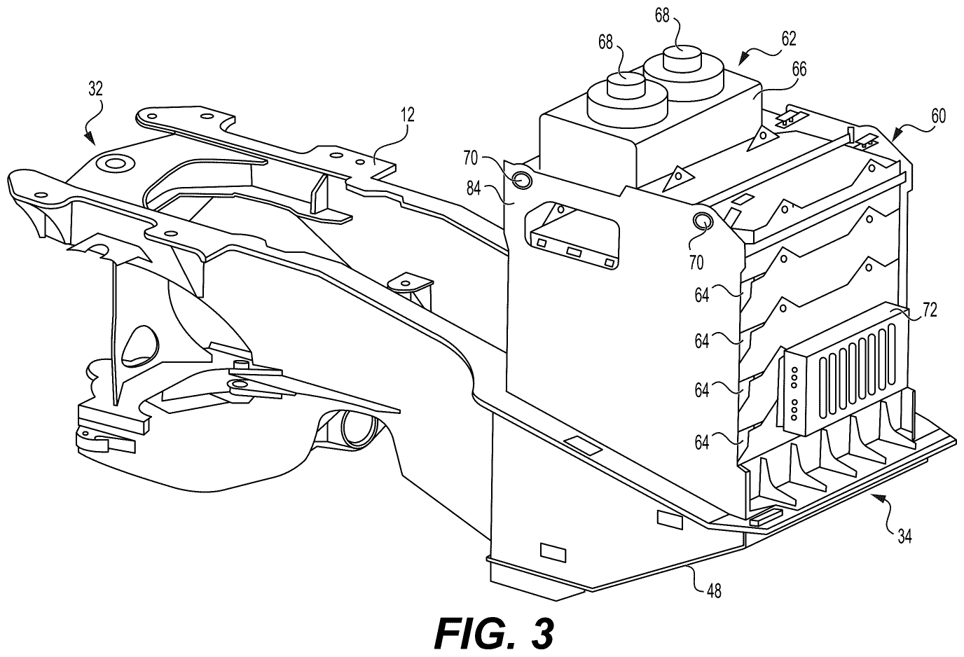

FIG. 3 illustrates an exemplary battery module assembly 60 positioned in tub 36 of chassis 12. At least a portion of battery module assembly 60 may be received within tub 36, whereas a remaining portion of battery module assembly 60 may protrude outside tub 36. Battery module assembly 60 may be attached to chassis 12 via one or more fasteners (not shown) passing through the one or more mounting holes 52 (see FIG. 2). Battery module assembly 60 may include battery module cooling system 62 configured to cool one or more battery modules 64 located within battery module assembly 60. In one exemplary embodiment as illustrated in FIG. 3, battery module cooling system 62 may be positioned above (e.g., on top of) at least some of battery modules 64 located in battery module assembly 60. However, in other exemplary embodiments, battery module cooling system 62 may be located on a side of battery module assembly 60 or anywhere else in machine 10.

In one exemplary embodiment, battery module cooling system 62 may include a heat exchanger 66 and one or more fans 68 configured to cool heat exchanger 66. Heat exchanger 66 may be configured to absorb heat generated by the one or more battery modules 64 and release the absorbed heat to the ambient atmosphere via the air supplied by the one or more fans 68. For example, heat exchanger 66 may be connected to one or more cold plates (not shown) associated with battery modules 64 via fluid ducts (not shown). Fluid flowing through the ducts and the cold plates may absorb heat from the one or more battery modules 64 and the heated fluid may be delivered to heat exchanger 66. Air supplied by the one or more fans 68 may in turn cool the heated fluid in the heat exchanger 66 by transferring the heat from the heated fluid to the ambient atmosphere. The disclosed heat exchanger 66 and fans 68 are exemplary and other cooling mechanisms, for example, forced air cooling systems, thermoelectric cooling systems, heat pipe cooling systems, or any other method of removing heat from battery modules 64 may be implemented in battery module cooling system 62.

Battery module assembly 60 may include one or more openings 70 in one or more structural members of battery module assembly 60. The one or more openings 70 may provide lifting locations, for example, to allow a hook or other device to engage with the one or more openings 70, allowing battery module assembly 60 to be raised from or lowered into tub 36 using a crane or other lifting device.

Battery module assembly 60 may include battery distribution unit 72. Battery distribution unit 72 may be configured to electrically connect the one or more battery modules 64 and supply a desired voltage or current to the prime mover of machine 10. For example, battery modules 64 may be divided into a plurality of groups of battery modules such that battery modules 64 in a particular group may be connected in series in battery distribution unit 72. Each group of battery modules 64 may then be connected in parallel in battery distribution unit 72 such that a voltage level equivalent to that provided by each group may be delivered to the prime mover. In one exemplary embodiment as illustrated in FIG. 3, battery distribution unit 72 may be located on a rearward face or rear wall of battery module assembly 60. It is contemplated, however, that battery distribution unit 72 may be located anywhere on battery module assembly 60 and/or machine 10.

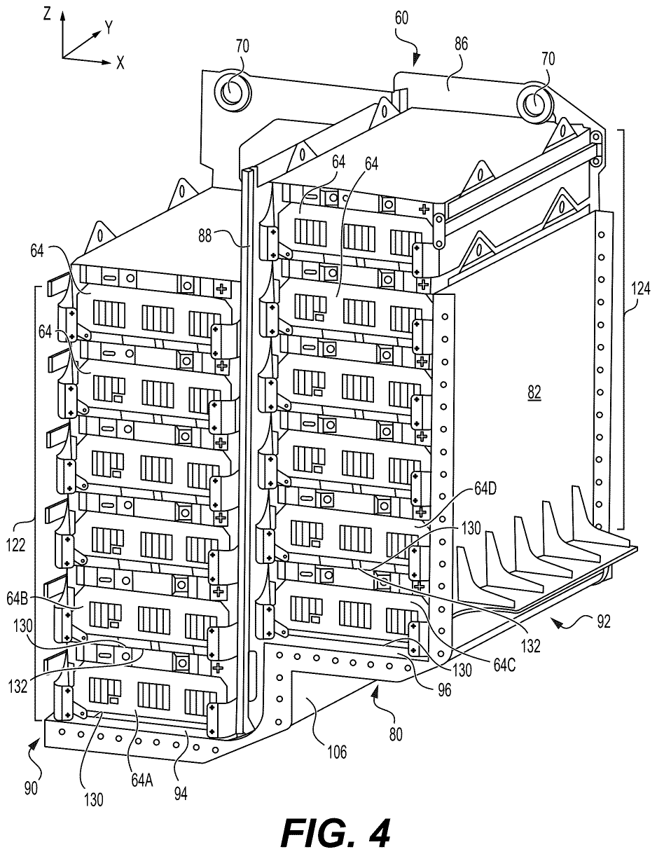

FIG. 4 illustrates an exemplary battery module assembly 60 with one of the side plates removed to illustrate the internal configuration. Battery module assembly 60 may include floor plate 80, rear plate 82, side plate 84 (see FIG. 3), and side plate 86. In one exemplary embodiment as illustrated in FIG. 4, battery module assembly 60 may include inner plate 88. Floor plate 80 may have a stair-step shape and may extend from front end 90 to rear end 92 of floor plate 80 along a length direction or longitudinal direction (e.g., X direction) parallel to longitudinal axis 50 (see FIG. 2). Floor plate 80 may extend in a width direction (e.g., Y direction) transverse to the length direction, and may have a width that may be smaller than a distance between side walls 40 and 42 (see FIG. 2) of tub 36 (see FIG. 2).

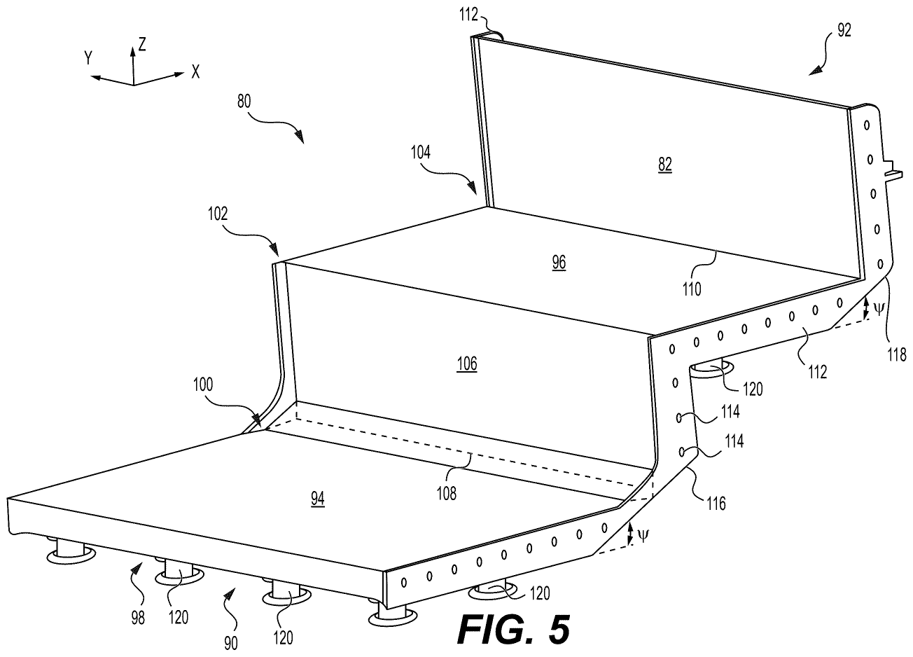

FIG. 5 illustrates an enlarged, perspective view of an exemplary floor plate 80. Floor plate 80 may include first shelf 94 and second shelf 96 that may be spaced apart from first shelf 94 in a first direction that may be generally perpendicular to the first shelf and/or the second shelf (e.g., Z direction or height direction) that is transverse to the length and width directions of floor plate 80. First shelf 94 and second shelf 96 may be disposed generally parallel to each other and may be offset from each other along the longitudinal direction (e.g., X direction) of floor plate 80. Thus, for example, first shelf 94 may extend from first shelf front end 98 to first shelf rear end 100. First shelf front end 98 may coincide with front end 90 of floor plate 80. Second shelf 96 may extend from second shelf front end 102 to second shelf rear end 104 that may coincide with rear end 92 of floor plate 80. Second shelf front end 102 may be located rearward of first shelf rear end 100.

Rear plate 82 may extend in the first direction (e.g., Z direction or height direction) from second shelf 96 adjacent to rear end 92 of floor plate 80. Similarly riser 106 may extend from second shelf front end 102 towards first shelf rear end 100, and may be connected to first shelf rear end 100. In some exemplary embodiments, first shelf 94 may intersect with riser 106 along first edge 108. Similarly, second shelf 96 may intersect with rear plate 82 along second edge 110. In some exemplary embodiments, a height or spacing (e.g., in the Z direction) of second shelf 96 relative to first shelf 94 may be selected such that a plane passing through first edge 108 and second edge 110 may be disposed at an angle about equal to or greater than the departure plane angle. Riser 106 may extend in one or more directions transverse to first shelf 94 and second shelf 96. First shelf 94, riser 106, and second shelf 96 may form the stair-step shape of floor plate 80. In some exemplary embodiments, one or more of first shelf 94, riser 106, second shelf 96, and/or rear plate 82 may include side walls 112 that may include one or more openings 114. One or more fasteners (not shown) may pass through openings 114 and may be configured to connect side plates 84 and 86 with one or more of first shelf 94, riser 106, second shelf 96, and/or rear plate 82.

Side walls 112 and/or one or more of first shelf 94, riser 106, shelf 96, and rear plate 82 may include chamfered surfaces such as 116 and 118 that may be inclined at an angle ψ relative to first shelf 94 and second shelf 96, respectively. In some exemplary embodiments, angle ψ may be about equal to angle θ (FIG. 2). These chamfered surfaces (e.g., 116 and 118) may allow floor plate 80 to rest on and be in contact with bottom wall 48 (see FIG. 2) of tub 36 (see FIG. 2) when battery module assembly (see FIG. 4) is inserted into tub 36. As also illustrated in FIG. 5, floor plate 80 may be equipped with one or more isolation mounts 120 configured to connect floor plate 80 with chassis 12 and/or bottom wall 48 of tub 36. Isolation mount 120 may include a resilient material sandwiched between a pair of structural members (e.g., plates) and held together with fasteners, adhesives, or any other method of attachment. The resilient material in isolation mount 120 may be made of materials capable of absorbing vibrations to dampen vibrations between chassis 12 and/or tub 36 on the one hand and floor plate 80 and battery module assembly 60 on the other hand.

Returning to FIG. 4, battery module assembly 60 may include first battery array 122 and second battery array 124. Each of first battery array 122 and second battery array 124 may include a plurality of battery modules 64. A number of battery modules 64 in first battery array 122 may be equal to or different from a number of battery modules 64 in second battery array 124. First battery array 122 may be positioned on first shelf 94 and second battery array 124 may be positioned on second shelf 96. Because of the stair step shape of floor plate 80, the first battery array 122 and second battery array 124 may be arranges along the departure plane or along a plane disposed at an angle θ that may be greater than the departure plane angle φ. When the first battery array 122 and second battery array 124 and second battery array are arranged along the departure plane, the plane passing through first edge 108 and second edge 110 may be disposed tangentially to at least one portion of a lowermost battery module 64 in both the first battery array 122 and the second battery array 124 and may be inclined at an angle φ corresponding to the departure plane angle relative to a horizontal plane. One or more battery modules 64 in the first battery array 122 and/or second battery array 124 may be attached to each other and/or to one or both of side plates 84 and 86.

In one exemplary embodiment as illustrated in FIG. 4, battery module assembly 60 may include inner plate 88 that may extend in a height direction (e.g. Z direction). For example, as illustrated in FIG. 4, inner plate 88 may extend from first shelf 94 and may be positioned between front end 90 of floor plate 80 and riser 106. For example, as illustrated in FIG. 4, inner plate 88 may be disposed adjacent to and spaced apart from riser 106. In some exemplary embodiments, inner plate 88 may be positioned above riser 106 and may extend in the height direction (e.g., Z direction) from second shelf 96. It is also contemplated that in some exemplary embodiments, battery module assembly 60 may not include inner plate 88.

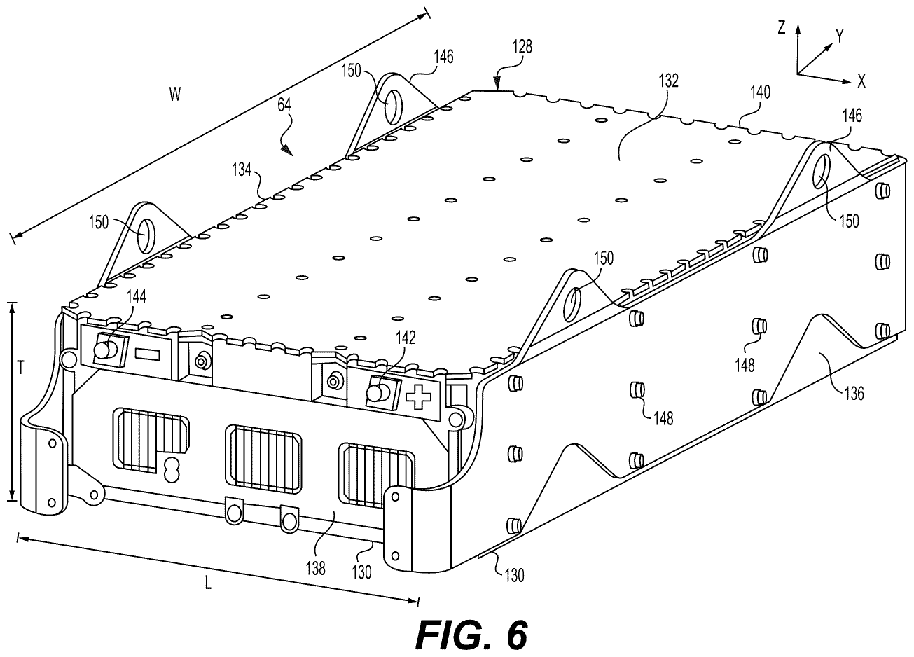

FIG. 6 illustrates an enlarged view of an exemplary battery module 64. Battery module 64 may include battery module housing 128 that may include bottom face 130, top face 132, front face 134, rear face 136, and side faces 138 and 140. Bottom face 130 and top face 132 may each have a length “L” (e.g., along the X direction) and a width “W” (e.g., along the Y direction). Length L and width W may be equal or unequal. Furthermore, length L may be smaller than or larger than width W. Top face 132 may be disposed parallel to and spaced apart from bottom face 130 in the height direction (e.g., Z direction) by a thickness “T” of battery module 64. Front face 134 may be disposed parallel to and spaced apart from rear face 136 along the length direction (e.g., along the X direction). Each of front face 134 and rear face 136 may extend along the length L of bottom face 130 and top face 132 and across the thickness T of battery module 64. Each of front face 134 and rear face 136 may be connected to bottom face 130 and top face 132. Side faces 138 and 140 may be disposed parallel to and spaced apart from each other along the width direction (e.g., along the Y direction). Each of side faces 138 and 140 may extend along the width W of bottom face 130 and top face 132 and across the thickness T of battery module 64. Each of side faces 138 and 140 may be connected to bottom face 130 and top face 132. Although battery module 64 has been illustrated and described as having a generally cuboid shape with reference to FIG. 6, battery module 64 may be cylindrical, may have a polygonal shape, or may have any other shape.

Battery module housing 128 may enclose a plurality of batteries or cells that may be connected in various arrangement (e.g., in series and/or parallel) to provide a battery module voltage across terminals 142 and 144. In some exemplary embodiments, battery module 64 may also include one or more brackets 146 connected to one or more of bottom face 130, top face 132, front face 134, rear face 136, and side faces 138 and 140. For example, as illustrated in FIG. 6, brackets 146 may be connected to front face 134 and rear face 136 via one or more fasteners 148. Brackets 146 may be configured to connect battery module 64 to inner plate 88, to other battery modules 64, and/or to side plates 84 and/or 86 (see FIGS. 3, 4). In other exemplary embodiments, brackets 146 may be connected to side faces 138 and/or 140. Brackets 146 may include one or more openings 150 that may allow a hook or other device to be engaged with the one or more openings 150, allowing battery module 64 to be raised, lowered, or moved into position, using a crane or other lifting device.

Returning to FIG. 4, battery modules 64 may be arranged in a variety of ways to form first battery array 122 and second battery array 124. In some exemplary embodiments as illustrated in FIG. 4, one or both of first battery array 122 and second battery array 124 may include a plurality of battery modules 64 stacked on top of each other in the height direction (e.g., Z direction). That is, bottom face 130 of one battery module 64 and top face 132 of adjacently located battery module 64 may face each other and/or may abut on each other. In this stacked configuration, front faces 134, rear faces 134, and side faces 138, 140 of the stacked battery modules 64, respectively, may be coplanar or may be parallel to each other. For example, as illustrated in FIG. 4, first battery array 122 includes battery modules 64A and 64B and top face 132 of battery module 64A faces and/or abuts on bottom face 130 of battery module 64B. As also illustrated in FIG. 5, bottom face 130 of lowermost battery module 64A in first battery array 122 may abut on and/or may be supported by first shelf 94. Similarly, for example, second battery array 124 may include battery modules 64C and 64D and top face 132 of battery module 64C faces and/or abuts on bottom face 130 of battery module 64D. As also illustrated in FIG. 5, lowermost battery module 64C in second battery array 124 has bottom face 130 that may abut on and/or may be supported by second shelf 96.

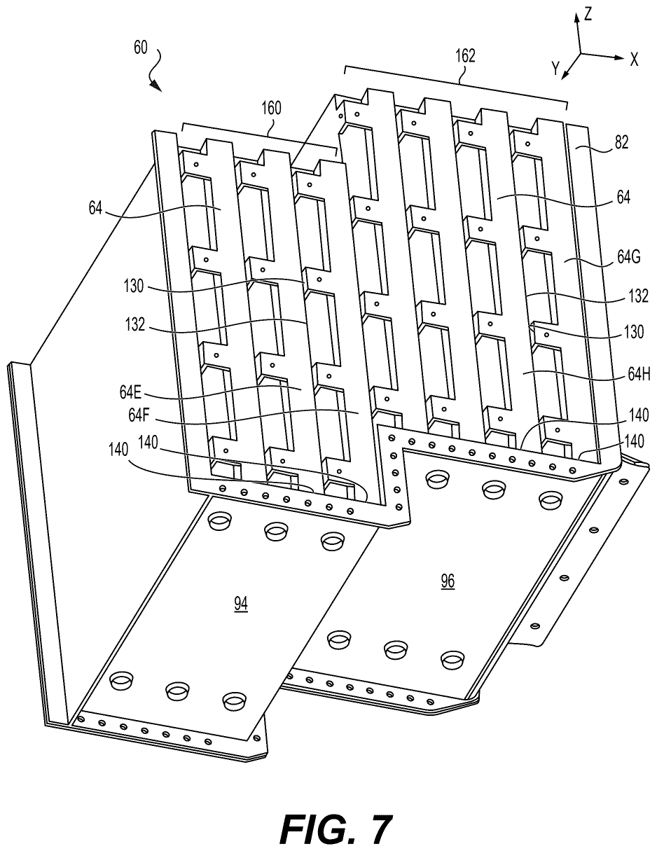

FIG. 7 illustrates another exemplary battery array 160 with one of the side plates removed to illustrate the internal configuration. Battery module assembly 60 may include first battery array 160 positioned on first shelf 94 and second battery array 162 positioned on shelf 96. First and second battery arrays 160 and 162 may include one or more battery modules 64 that may be similar to the battery modules 64 included in, for example, battery arrays 122 and 124. A number of battery modules 64 in first battery array 160 may be equal to or different from a number of battery modules 64 in second battery array 162. In some exemplary embodiments as illustrated in FIG. 7, one or both of first battery array 160 and second battery array 162 may include a plurality of battery modules 64 stacked sideways relative to each other in the length direction (e.g., X direction). Stacking battery modules 64 sideways refers to an orientation in which one of front face 134, rear face 136, or side faces 138 or 140 of battery modules 64 abuts on or is supported by first or second shelf 94 or 96. That is, bottom face 130 and top face 132 of adjacently located battery modules 64 may face each other and/or may abut on each other, while one of side faces 138 or 140 or one of front and rear faces 134 and 136, respectively, may be supported by first shelf 94 or second shelf 96. For example, as illustrated in FIG. 7, first battery array 160 include battery modules 64E and 64F with top face 132 of battery module 64E facing and/or abutting on bottom face 130 of battery module 64F. As also illustrated in FIG. 7, side faces 140 of battery modules 64E and 64F may abut on and/or may be supported by first shelf 94. By way of another example, as illustrated in FIG. 7, second battery array 162 include battery modules 64G and 64H with top face 132 of battery module 64H facing and/or abutting on bottom face 130 of battery module 64H. As also illustrated in FIG. 7, side faces 140 of battery modules 64G and 64H may abut on and/or may be supported by second shelf 96.

Although first battery array 122 and second battery array 124 have been illustrated in FIG. 4 as being stacked on top of each other, the configuration of first battery array 122 and second battery array 124 is not so limited. One or both of first battery array 122 and second battery array 124 may include battery modules 64 stacked on top of each other as shown in FIG. 4 or stacked sideways as shown in FIG. 7. Similarly, although first battery array 160 and second battery array 162 have been illustrated in FIG. 7 as being stacked sideways, the configuration of first battery array 160 and second battery array 162 is not so limited. One or both of first battery array 160 and second battery array 162 may include battery modules 64 stacked on top of each other as shown in FIG. 4 or stacked sideways as shown in FIG. 7.

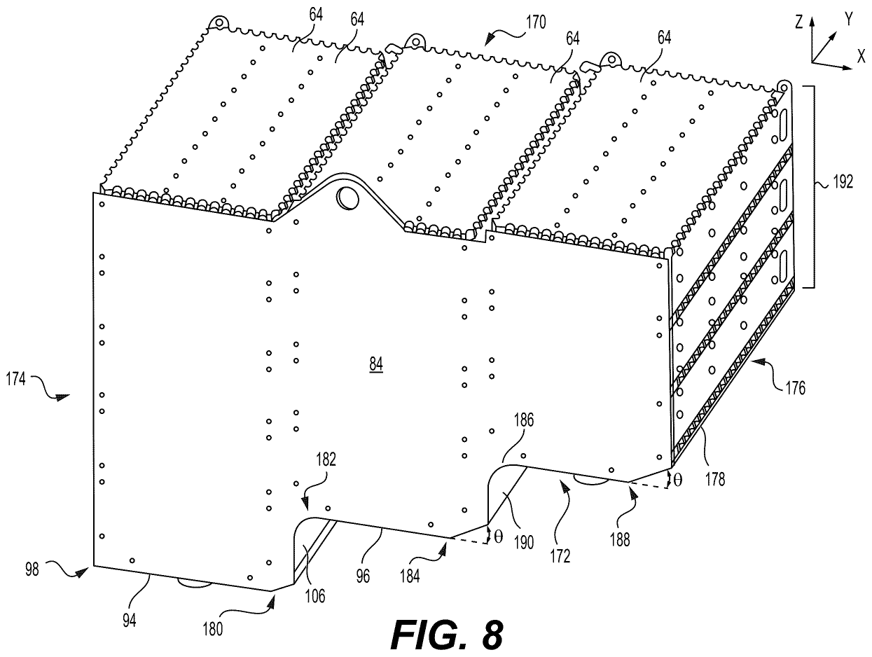

FIG. 8 illustrates another exemplary battery module assembly 170 that may include floor plate 172, a rear plate (similar to rear plate 82, not shown), side plate 84, and side plate 86 (not shown). Like floor plate 80, floor plate 172 may have a stair-step shape and may extend from front end 174 to rear end 176 along a length direction or longitudinal direction (e.g., X direction) parallel to longitudinal axis 50 (see FIG. 2). Floor plate 80 may extend in a width direction (e.g., Y direction) transverse to the length direction, and may have a width that may be smaller than a distance between side walls 40 and 42 (see FIG. 2) of tub 36 (see FIG. 2). Floor plate 172 may include first shelf 94, second shelf 96, and third shelf 178. Second shelf 96 may be spaced apart from first shelf 94 in the first direction (e.g., Z direction or height direction) that is transverse to the length and width directions of floor plate 172. Similarly, third shelf 178 may be spaced apart from second shelf 96 in the first direction (e.g., Z direction or height direction) that is transverse to the length and width directions of floor plate 172. First shelf 94 and second shelf 96 may be disposed generally parallel to each other and may be offset from each other along the length direction of floor plate 172. Similarly, second shelf 96 and third shelf 178 may be disposed generally parallel to each other and may be offset from each other along the length direction of floor plate 172. Thus, for example, first shelf 94 may extend from first shelf front end 98 to first shelf rear end 180, second shelf 96 may extend from second shelf front end 182 to second shelf rear end 184, and third shelf 178 may extend from third shelf front end 186 to third shelf rear end 188. First shelf front end 98 may coincide with front end 174 of floor plate 172. Third shelf rear end 188 may coincide with or may be located adjacent to rear end 176 of floor plate 172. Second shelf front end 182 may be located rearward of first shelf rear end 180, and third shelf front end 186 may be located rearward of second shelf rear end 184.

Riser 106 may extend from second shelf front end 182 towards first shelf rear end 180, and may be connected to first shelf rear end 180. Riser 190 may extend from third shelf front end 186 towards second shelf rear end 184 and may be connected to second shelf rear end 184. Thus, first shelf 94, riser 106, second shelf 96, riser 190, and third shelf 178 may form the stair-step shape of floor plate 172. In some exemplary embodiments, one or more of first shelf 94, riser 106, second shelf 96, riser 190, third shelf 178, and/or rear plate 82 may include side walls (similar to side walls 112, not shown) that may include one or more openings (similar to openings 114, not shown). One or more fasteners (not shown) may pass through the openings and may be configured to connect side plates 84 and 86 with one or more of first shelf 94, riser 106, second shelf 96, riser 190, third shelf 178, and/or rear plate 82. Like battery module assembly 60, the side walls (similar to side walls 112, not shown) and/or one or more of first shelf 94, riser 106, second shelf 96, riser 190, and rear plate 82 may include chamfered surfaces that may be inclined at an angle θ relative to first shelf 94, second shelf 96, and third shelf 178. These chamfered surfaces may allow floor plate 172 to rest on and be in contact with bottom wall 48 (see FIG. 2) of tub 36 (see FIG. 2) when battery module assembly 170 is inserted into tub 36.

Battery module assembly 170 may include first battery array 122, second battery array 124, and third battery array 192, each of which may each include a plurality of battery modules 64. It is contemplated that battery modules 64 in one or more first battery array 122, second battery array 124, and third battery array 192 may be stacked in a height direction as illustrated in FIG. 4, sideways as illustrated in FIG. 6, or any combination thereof. The number of battery modules 64 in first battery array 122, second battery array 124, and third battery array 192 may be equal or unequal. Although floor plate 80 with two shelves 94 and 96 has been illustrated and described with reference to FIG. 4 and floor plate 172 with three shelves 94, 96, and 178 has been illustrated in and described with reference to FIG. 8, battery module assembly 60 may include other floor plates that may have more than two or three shelves and may accommodate more than two or three sets of battery modules 64.

### INDUSTRIAL APPLICABILITY

The disclosed battery module assemblies 60 or 170 may be used to provide electrical power to one or more prime movers in machines 10, such as wheel loaders, cable shovels, drag lines, electric rope shovels, excavators, and front shovels. Specifically, the disclosed battery module assemblies 60 or 170 may be insertable in a tub 36 or recess in a chassis 12 of machine 10. The stair-step design of the floor plate 80 or 172, and use of tub 36 to accommodate battery modules 64 may allow for arrangement of battery modules 64 on machine 10 machine without requiring any increase in width of machine 10 relative to a similar machine having a combustion engine as a prime mover. Similarly, the stair-step design of the floor plate 80 or 172, and use of tub 36 may allow some of the battery modules 64 to be located within tub 36 outside of chassis 12. This in turn may ensure that a height of an uppermost battery module 64 relative to chassis 12 does not obstruct a view of an operator of machine 10 in a rearward direction (e.g., in the X direction or in a direction from front end 32 towards rear end 34 of chassis 12). The stair-step design of floor plate 80 or 172 may also allow floor plate 80 or 172 to conform to the shape of the bottom rear surface (or bottom wall 48) of machine 10, while still allowing a sufficient number of battery modules 64 needed or desired to provide power for operations of machine 10 for an entire work day, without requiring replacement or recharging of batteries.

Machines 10 such as wheel loaders often operate while being located partially on sloping surfaces. For example, a front traction device 14 of machine 10 may be positioned on a mound of construction material while the rear traction device 16 may remain on an adjoining ground at a different elevation. To ensure that the body of machine 10 does not touch the ground surface in such orientations, the bottom rear surface (or bottom wall 48) of tub 36 of machine 10 is designed to be inclined at an angle θ (that is greater than a departure angle φ) relative to the horizontal surface. This helps ensure that bottom wall 48 does not touch the ground surface even when machine 10 is tilted at the departure angle φ relative to the ground surface.

It will be apparent to those skilled in the art that various modifications and variations can be made to the disclosed battery module assemblies. Other embodiments will be apparent to those skilled in the art from consideration of the specification and practice of the disclosed battery module assemblies. It is intended that the specification and examples be considered as exemplary only, with a true scope being indicated by the following claims and their equivalents.

What is claimed is:

1. A battery module assembly, comprising:
a floor plate having a stair-step shape, the floor plate including a first shelf and a second shelf spaced apart from the first shelf along a first direction generally perpendicular to the first shelf and the second shelf;
a rear plate extending in the first direction from a rear end of the floor plate;
a pair of side plates extending between a front end of the floor plate and the rear end of the floor plate, the side plates being connected to one or more of the floor plate and the rear plate;
a first battery array including a first plurality of battery modules positioned on the first shelf; and
a second battery array including a second plurality of battery modules positioned on the second shelf, such that at least one battery module of the first battery array and the second battery array is attached to at least one of the pair of side plates.

2. The battery module assembly of claim 1, further including one or more isolation mounts configured to attach the floor plate to a chassis of machine.

3. The battery module assembly of claim 1, wherein each battery module of the first battery array and each battery module of the second battery array includes:
a bottom face;
a top face spaced apart from the bottom face by a thickness, each of the bottom face and the top face having a length and a width;
side faces extending between the width of the bottom face and the width of the top face;
a front face extending between the length of the bottom face and the length of the top face; and
a rear face extending between the length of the bottom face and the length of the top face.

4. The battery module assembly of claim 3, wherein:
the first plurality of battery modules are positioned such that the bottom face of at least one battery module in the first battery array faces or abuts the top face of at least one other battery module in the first battery array; and
the second plurality of battery modules are positioned such that the bottom face of at least one battery module in the second battery array faces or abuts the top face of at least one other battery module in the second battery array.

5. The battery module assembly of claim 4, wherein:
the bottom face of a lowermost battery module of the of first battery array is supported by the first shelf; and
the bottom face of a lowermost battery module of the second battery array is supported by the second shelf.

6. The battery module assembly of claim 4, wherein
one of the side faces, the front face, or the rear face of each battery module of the first battery array is supported by the first shelf, and
one of the side faces, the front face, or the rear face of each battery module of the second battery array is supported by the second shelf.

7. The battery module assembly of claim 1, further including a battery module cooling system configured to cool the first plurality of battery modules and the second plurality of battery modules.

8. The battery module assembly of claim 1, further including a battery distribution unit electrically connected to the first plurality of battery modules and the second plurality of battery modules.

9. The battery module assembly of claim 1, wherein
the first shelf extends from a first shelf front end to a first shelf rear end,
the second shelf extends from a second shelf front end to a second shelf rear end, the second shelf front end being positioned longitudinally spaced apart from the first shelf rear end,
the second shelf is located above the first shelf in the first direction,
the rear plate extends vertically from the second shelf adjacent to the second shelf rear end, and
the floor plate further includes a riser extending between the first shelf rear end and the second shelf front end.

10. The battery module assembly of claim 9, wherein an inner plate is positioned between the front end of the floor plate and the riser.

11. The battery module assembly of claim 1, further including an opening in each of the side plates, the opening being configured to provide a lifting point for the battery module assembly.

12. The battery module assembly of claim 1, further including
a third shelf spaced apart from the second shelf of the floor plate in the first direction, and
a third battery array positioned on the third shelf, the third battery array including a third plurality of battery modules.

13. The battery module assembly of claim 12, further including an equal number of battery modules in the first battery array, the second battery array, and the third battery array.

14. A method of arranging battery modules in a machine, the method comprising:
providing a floor plate having a stair-step shape, the floor plate including a first shelf and a second shelf spaced apart from the first shelf along a first direction generally perpendicular to the first shelf and the second shelf;
providing a rear plate extending in the first direction from a rear end of the floor plate;
providing a pair of side plates extending between a front end of the floor plate and the rear end of the floor plate, the sides plate being connected to one or more of the floor plate and the rear plate;
arranging a first battery array including a first plurality of battery modules on the first shelf; and
arranging a second battery array including a second plurality of battery modules on the second shelf.

15. The method of claim 14, wherein
each battery module of the first battery array and the second battery array includes:
a bottom face,
a top face spaced apart from the bottom face by a thickness of the battery module, each of the bottom face and the top face having a length and a width,
side faces extending across thickness along the width, and
front and rear faces extending across the thickness along the length, and
the method further includes arranging the first plurality of battery modules on the first shelf such that the bottom face of at least one battery module in the first battery array faces or abuts a top face of at least one other battery module in the first battery array.

16. The method of claim 15, further including arranging the first plurality of battery modules on the first shelf such that the bottom face of a lowermost battery module of the first plurality of battery modules is supported by the first shelf or one of the side faces of each of the first plurality of battery modules is supported by the first shelf.

17. A machine, comprising:
a frame extending from a front end to a rear end and including a tub adjacent to the rear end;
a rear axle extending transverse to the frame adjacent to the rear end of the frame;
a pair of traction devices being attached to opposite ends of the rear axle;
a battery module assembly receivable in the tub, the battery module assembly including:
a floor plate having a stair-step shape, the floor plate including a first shelf and a second shelf spaced apart from the first shelf along a first direction generally perpendicular to the first shelf and the second shelf;
a rear plate extending in the first direction from a rear end of the floor plate;
a pair of side plates extending between a front end of the floor plate and the rear end of the floor plate, the side plates being connected to at least one of the floor plate and the rear plate;
a first battery array positioned on the first shelf, the first battery array including a first plurality of battery modules; and
a second battery array positioned on the second shelf, the second battery array including a second plurality of battery modules,
wherein the first battery array and the second battery array are arranged along a departure plane of the machine.

18. The machine of claim 17, wherein
the first shelf extends from a first shelf front end to a first shelf rear end,
the second shelf extends from a second shelf front end to a second shelf rear end, the second shelf front end being positioned adjacent to the first shelf rear end,
the second shelf is located above the first shelf in the first direction, and
the floor plate further includes a riser extending between the first shelf rear end and the second shelf front end.

19. The machine of claim 18, wherein
the first plurality of battery modules are positioned on the first shelf such that a bottom face of at least one battery module in the first battery array faces or abuts a top face of at least one other battery module in the first battery array, and
the second plurality of battery modules are positioned on the second shelf such that a bottom face of at least one battery module in the second battery array faces or abuts a top face of at least one other battery module in the second battery array.

20. The machine of claim 18, wherein
the first plurality of battery modules are positioned on the first shelf such that a bottom face and a top face of adjacently located battery modules in the first plurality of battery modules face each other, and one of the side faces of each of the first plurality of battery modules is supported by the first shelf, and
the second plurality of battery modules are positioned on the second shelf such that a bottom face and a top face of adjacently located battery modules in the second plurality of battery modules face each other, and one of the side faces of each of the second plurality of battery modules is supported by the second shelf.
